(19) United States
(12) Patent Application Publication
(10) Pub. No.: US 2019/0334140 A1
(43) Pub. Date: Oct. 31, 2019

(54) BATTERY HOLDING DEVICE, AND AIRCRAFT HAVING A BATTERY HOLDING DEVICE OF THIS TYPE

(71) Applicant: Airbus Operations GmbH, Hamburg (DE)

(72) Inventor: Peter LINDE, Hamburg (DE)

(21) Appl. No.: 16/394,374

(22) Filed: Apr. 25, 2019

(30) Foreign Application Priority Data
Apr. 27, 2018 (DE) 102018110269.0

(51) Int. Cl. H01M 2/10; B65D 21/02; H01M 10/42

(52) U.S. Cl. CPC H01M 2/1077; B65D 2585/88; H01M 10/4207; B65D 21/0204

(57) ABSTRACT

A battery holding device for an aircraft, having a support formed from a solid foam and a continuous-fiber-reinforced plastic material connected to the foam, a plurality of cavities into which batteries are insertable, and at least one cooling duct for cooling batteries that are insertable into the cavities. The cavities are formed by the support. An aircraft having a battery holding device of this type is also provided.

### CROSS-REFERENCES TO RELATED APPLICATIONS

This application claims the benefit of the German patent application No. 10 2018 110 269.0 filed on Apr. 27, 2018, the entire disclosures of which are incorporated herein by way of reference.

### FIELD OF THE INVENTION

The invention relates to a battery holding device as well as to an aircraft having a holding device of this type.

### BACKGROUND OF THE INVENTION

Battery holding devices are, in principle, known from the prior art. For example, plastic material boxes into which batteries are insertable are known from the construction of scale models. Boxes of this type in a significantly larger scale are also used in other practical applications. For example, boxes which are similar to drawers and into which the batteries are insertable in order for the batteries to be handled in a simple manner conjointly with the boxes are known. Moreover, the boxes often serve for protecting the batteries.

In order for a particularly reliable protection for batteries to be guaranteed, rectangular-tubular housings from plastic material into which batteries that are fastened to fastening plates can be pushed-fitted into the housing are moreover known. In order for a housing of this type to be able to be particularly reliably handled conjointly with the batteries, the housing has a particularly high dimensional stability and/or rigidity. Housings of this type indeed offer a particularly good protection for batteries, but the access to the battery in the battery housing is possible only with difficulty. For example, in order to be able to replace one of the batteries, the fastening plate first has to be extracted from the housing so as to then have access to the respective battery.

However, battery holding devices of this type are not very suitable for aircraft. The fastening plates as well as the housing cause a weight which has to be carried on-board by the aircraft, which, in turn, requires an additional output for propelling the aircraft. This, however, is to be avoided.

### SUMMARY OF THE INVENTION

The invention is therefore based on an object of providing a light and robust battery holding device having a support for batteries, the support permitting a simple replacement of batteries such that the battery holding device is suitable for the use in an aircraft.

A battery holding device for an aircraft is thus provided, wherein the battery holding device has a support which is formed from a solid foam and continuous-fiber-reinforced plastic material that is connected to the foam. Moreover, the battery holding device has a plurality of cavities into which the batteries are insertable. Moreover, the battery holding device has at least one cooling duct for cooling batteries that are insertable into the cavities. The cavities are formed by the support.

The foam is preferably an open-pore or closed-pore foam. The foam is solid foam. The foam can also be referred to as foam material. This is thus not liquid foam. The foam can thus be a polyurethane foam, for example. Alternatively or additionally, it can be provided that the foam is configured as a polymer-based foam. Moreover, it has proven advantageous for the foam to be configured as a non-combustible and/or as a non-flammable foam. The foam can thus have a substance which prevents any ignition of the foam. The foam can have an arbitrary external shape. The foam can thus have a rectangular external shape, for example.

It is moreover preferably provided that the support is formed from the foam and the fiber-reinforced plastic material having continuous fibers. The continuous-fiber-reinforced plastic material can be formed by solid matrix material into which continuous fibers are embedded. The fibers are, for example, glass fibers, carbon fibers and/or aramid fibers. The fibers are configured as continuous fibers. The length of each of the fibers can thus correspond to at least the length of the shortest or the longest external side of the support, for example. Each continuous fiber particularly preferably has a length which corresponds to a multiple of a mean external length of the support. The continuous-fiber-reinforced plastic material will hereunder also be referred to in a simplified manner as a fiber-reinforced plastic material. The fiber-reinforced plastic material can be integrated in the foam in the shape of strands. On account thereof, a framework and/or a structure in the manner of a trussed girder of a plurality of strand-shaped portions of the fiber-reinforced plastic material can be formed. It is furthermore possible that at least one external side, and presently preferably in portions, is formed by the fiber-reinforced plastic material. However, it is preferably provided that at least two opposite external sides, preferably two pairs of opposite external sides, are free of the fiber-reinforced plastic material, or are at least not completely covered by the fiber-reinforced plastic material. Rather, it is preferably provided that only two opposite external sides of the support are at least in portions covered by the fiber-reinforced plastic material. The fiber-reinforced plastic material can be cured fiber-reinforced plastic material. The matrix material herein can be a thermosetting matrix material or a thermoplastic matrix material, for example.

Moreover, the cavities into which the batteries are insertable are formed by the support. It is thus preferably provided that the cavities are formed by the solid foam and/or from a combination of the solid foam and the fiber-reinforced plastic material of the support. The cross section of each one of the cavities can be chosen in such a manner that the cavity corresponds to an external shape of the battery to be inserted. It is preferably provided that the space defined by the support between the cavities is filled with the solid foam and/or the fiber-reinforced plastic material. It is effectively prevented on account thereof that voids which neither serve for inserting the batteries nor are filled with the solid foam or the fiber-reinforced plastic material exist in the support. This in turn guarantees a particularly high dimensional stability of the battery holding device.

It is preferably provided that the support has a dimensional stability and/or strength and/or rigidity which are/is predetermined in such a manner that the support can in a self-acting manner support the batteries that are insertable into the cavities. A particularly advantageous handling capability of the battery holding device is guaranteed on account thereof. At the same time, the support formed by the solid foam and the fiber-reinforced plastic material is particularly light. In other words, a battery holding device of this type can guarantee a particularly low weight and at the same time a particularly high dimensional stability.

The battery holding device moreover has at least one cooling duct for cooling batteries that are insertable into the cavities. The cooling duct can be configured for conducting cooling fluid, in particular cooling liquid and/or a cooling gas such as air. Cooling fluid which is suitable for receiving heat can thus flow through the cooling duct, the heat being dissipated by the insertable batteries. To this end, the cooling duct can lead past the cavities into which the batteries are insertable, so as to be directly contiguous to the cavities. It is furthermore possible that the cooling duct is coupled to at least one portion of the casing wall of the cavities by heat-conducting elements such that heat is capable of being transmitted from a battery by way of the heat-conducting element to the cooling duct. In the latter, the heat can, in turn, be transmitted to the cooling fluid that is capable of being conducted through the cooling duct.

The battery holding device thus not only combines the advantages that the battery holding device is particularly light and dimensionally stable, but the battery holding device moreover offers a particularly advantageous cooling of batteries, this significantly improving the safety when using a battery holding device of this type. A battery holding device of this type is particularly advantageously suitable for use in an aircraft. Not only a weight reduction is pursued in the case of an aircraft, but the safety of the aircraft also requires particular attention.

One advantageous design embodiment of the battery holding device is distinguished in that the continuous-fiber-reinforced plastic material of the support is printed. The continuous-fiber-reinforced plastic material herein can be printed in webs or as a stanchion in such a manner that the webs or stanchions, respectively, are embedded in the solid foam. The continuous-fiber-reinforced plastic material of the support can be printed in such a manner that the continuous-fiber-reinforced plastic material serves and/or is configured for reinforcing and/or increasing the rigidity of the solid foam.

One further advantageous design embodiment of the battery holding device is distinguished in that at least part of the continuous-fiber-reinforced plastic material of the support is disposed on at least one external side of the support. The continuous-fiber-reinforced plastic material can thus be disposed on two opposite external sides of the support, for example. The remaining external sides of the support can be free of the continuous-fiber-reinforced plastic material. However, this is not mandatory. The continuous-fiber-reinforced plastic material can be disposed on the at least one external side of the support in such a manner that the continuous-fiber-reinforced plastic material bears on the solid foam.

One further advantageous design embodiment of the battery holding device is distinguished in that the foam is printed. The solid foam can thus be a printable foam, for example. On account of the printable foam, the external shape of that part of the support that is formed by the solid foam can be adapted in a particularly individual manner. It can thus be provided in practice that the battery holding device is individually adapted to the respective intended application. The same can apply in analogous manner to the printed solid foam. The latter can first be printed in the desired design embodiment. Thereafter, the continuous-fiber-reinforced plastic material can be printed on at least one external side of the foam such that the support is formed from the solid foam and the continuous-fiber-reinforced plastic material of the support that is connected to the foam. The matrix material of the continuous-fiber-reinforced plastic material and the solid foam can be based on the same matrix material. Both can thus be polyurethane-based or polymer-based, for example. The connection between the fiber-reinforced plastic material and the solid foam is preferably a materially integral connection.

One further advantageous design embodiment of the battery holding device is distinguished in that the foam is configured so as to be electrically isolating. The cavities for inserting the batteries are formed by the support and preferably by the solid foam of the support. When the foam is configured so as to be electrically isolating, this also offers a positive electrical isolation between the batteries in one cavity and the batteries in a further, in particular neighboring, cavity. It can be provided that the continuous-fiber-reinforced plastic material of the support is spaced apart from a casing wall of the cavities. This is advantageous, in particular, when the continuous-fiber-reinforced plastic material of the support comprises continuous fibers from carbon.

One further advantageous design embodiment of the battery holding device is distinguished in that the cavities are disposed within the support, wherein an access to each cavity is configured in a further or the external side of the support such that a battery is insertable into each cavity by way of the associated access. The cavities are preferably disposed within the solid foam of the support. An access to a cavity can be an opening on the external side which forms an access to the cavity. Therefore, a battery can be inserted into a cavity from the outside through the access. The accesses are preferably disposed on an external side which is free of fiber-reinforced plastic material. However, should the accesses be disposed on an external side of the support on which the continuous-fiber-reinforced plastic material is likewise disposed, it is preferably provided that recesses are provided in the fiber-reinforced plastic material at least in the region of the accesses.

One further advantageous design embodiment of the battery holding device is distinguished in that each cavity is configured for receiving a plurality of batteries. Each cavity can thus be configured for receiving a plurality of batteries successively disposed in a row, for example. This applies, in particular, when the batteries are configured as bar-shaped batteries. The cross section of the cavity can correspond to the cross section of the batteries to be received. For example, when circular-cylindrical rod-shaped batteries are to be received, it is preferably provided that the cavity is configured as a circular-cylindrical cavity.

The plurality of cavities can be aligned so as to be mutually parallel. This applies, in particular, when each cavity is configured as a circular-cylindrical cavity. The accesses in this instance can then be disposed on the end sides of the cavities on the same external side of the support, or on opposite external sides of the support.

One further advantageous design embodiment of the battery holding device is distinguished by electrical connection lines which are disposed for electrically connecting the insertable batteries in a predetermined structure. The electrical connection lines can be coupled and/or connected releasably or fixedly to the support. The connection lines can thus be formed by a foil/film having printed connection lines, for example. The foil/film can be disposed on an external side of the support in such a manner that battery terminals come into contact with the connection lines when the batteries are inserted into the cavities. The batteries can be electrically coupled to one another in a predetermined manner by way of the connection lines. A parallel circuit of the batteries can thus be provided, for example. Alternatively, another type of circuit of the batteries can also be provided. The batteries can thus be connected to one another in series, for example. A plurality of foils/films onto which electrical connection lines are printed can also be provided. The foils/films can be disposed on opposite external sides on the support in such a manner that identical terminal types of the batteries are in each case coupled to one another in groups. At least one of the foil/films can be releasably disposed on an external side of the support. However, it is also possible that at least one of the foil/films is fixedly disposed on an external side of the support.

One further advantageous design embodiment of the battery holding device is distinguished in that the electrical connection lines are disposed within the support and/or are at least in part integrated in the support. The connection lines can likewise be disposed in such a manner so as to electrically connect the batteries that are insertable into the cavities in the predetermined structure. The use of connection lines which are disposed within the support and/or are at least in part integrated in the support offers the advantage that the battery handling device is capable of being handled in a particularly simple and safe manner. Any wrong wiring of the batteries can be particularly effectively prevented in this way.

One further advantageous design embodiment of the battery holding device is distinguished in that the support is subdivided into a plurality of sections by walls, wherein each wall is formed from continuous-fiber-reinforced plastic material, and wherein the walls and the continuous-fiber-reinforced plastic material of the support are configured so as to be integral. The walls can be assigned to the support. In this case, the walls can be formed by the continuous-fiber-reinforced plastic material of the support. The continuous-fiber-reinforced plastic material of the walls herein can be configured so as to be integral to the remaining continuous-fiber-reinforced plastic material of the support. A particularly high dimensional stability of the support is guaranteed on account thereof. The solid foam can be disposed between the walls of the support. The cavities for inserting the batteries can be formed by the foam of the support. A multiplicity of cavities can be provided in each section. Since there can be a plurality of sections, a corresponding multiplicity of cavities can also be provided.

One advantageous design embodiment of the battery holding device is distinguished in that at least one portion of the cooling duct or one of the cooling ducts is configured on each wall. Each wall can thus serve as a support base for fastening a cooling duct. Alternatively or additionally, it can be provided that each wall forms at least part of the respective cooling duct. The cooling ducts can thus be at least in part configured integrally by the walls. The walls moreover offer a base for guaranteeing a predetermined disposal of the cooling ducts. Therefore, it is possible that the cooling ducts extend through the interior space of the support, which can ensure particularly effective cooling of the cavities or of the batteries insertable thereinto, respectively.

One advantageous design embodiment of the battery holding device is distinguished in that the walls and the support are configured so as to be printed by an uninterrupted method. Both, the solid foam as well as the continuous-fiber-reinforced plastic material of the support, as well as the walls can be configured so as to be printed. This can be carried out by an uninterrupted method. On account thereof, it is possible that stanchions and/or bar-shaped webs from fiber-reinforced plastic material are integrated within the foam, this particularly advantageously improving the dimensional stability of the support. The walls which are disposed within the support herein can also be produced by an integral type of method. One particularly advantageous design embodiment of the battery holding device is distinguished in that the walls are disposed so as to be mutually parallel within the support. A multiplicity of sections that are disposed in a mutually parallel manner can be created on account thereof. The sections can be designed so as to be at least substantially identical. A particularly high density in terms of cavities or batteries, respectively, within the support can be guaranteed on account thereof.

According to a second aspect of the invention, an aircraft which has a structural component and a battery holding device such as has been explained according to the first aspect of the invention and/or one of the associated advantageous design embodiments is provided. In this context, reference is made at least in analogous manner to the advantageous explanations, preferred features, effects and/or advantages as have already been explained in the context of the battery holding device. In the case of the aircraft it is moreover provided that at least one battery is inserted into each cavity of the support of the battery holding device. Moreover, the battery holding device is releasably disposed and/or fastened in an operating space that is protected and/or defined by the structural component.

The structural component of the aircraft is preferably a component of the supporting structure of the aircraft. The structural component can thus form a support function of the aircraft. A structural component of the aircraft can be, for example, a frame of the aircraft or a transverse support in the floor of the aircraft. The structural component here in can define and/or protect an operational frame. The structural component can be configured so as to be U-shaped or rectangular in the cross section, for example. The operational space can be configured in a longitudinal direction of the structural component which preferably extends so as to be perpendicular to the aforementioned cross section of the structural component. For example, when the structural component is formed by a U-shaped support component, the support component can configure a defined or protected operational space, respectively. The battery holding device can be inserted into the operational space. The battery holding device can thus be disposed in the operational space. Moreover, the battery holding device can be releasably fastened to the structural component. It has proven particularly advantageous herein for the battery holding device to be inserted into the operational space of the structural component in a form-fitting manner and/or to be connected to the structural component in a form-fitting manner. Moreover, a releasable force-fitting connection between the battery holding device and the structural component can be provided.

Batteries are inserted into the cavities of the support of the battery holding device. The batteries can be coupled to one another in a predetermined circuit mode by electrical connection lines. Moreover, it is preferably provided that the battery holding device is configured in such a manner that the electrical connection lines and/or the terminals of the batteries are designed so as to be protected and/or isolated in relation to the external sides of the support. On account thereof it can be effectively prevented that any undesirable electrical connection is established between the batteries and the structural component. The batteries can be rechargeable batteries. The batteries can thus be formed by lithium-iron rechargeable batteries, for example. Other batteries, in particular rechargeable batteries, are likewise possible.

As has already been illustrated in the context of the explanations pertaining to the battery holding device according to the first aspect, is preferably provided that the battery holding device can have a particularly high dimensional stability even when the batteries are inserted into the cavities of the support. This offers the advantage that the battery holding device inserted into the operational space of the structural component does at least not substantially cause any reinforcement of the structural component. In an ideal case it can rather be provided that no modification of the structural component is required in order for the battery holding device to be supported and/or held. On account thereof, the complexity in terms of construction in the case of an existing aircraft can be kept particularly minor when the battery holding device is to be inserted into operational spaces that are protected and/or defined by structural components.

One advantageous design embodiment of the aircraft is distinguished in that the structural component is configured so as to be hollow-cylindrical. The structural component can have an opening at least on an end side. The battery holding device can be inserted into the corresponding operational space through the opening, so as to dispose the battery holding device in the operational space and/or to releasably fasten the battery holding device to the structural component.

One advantageous design embodiment of the aircraft is distinguished in that the support of the battery holding device on the casing has an external shape which corresponds to an internal shape of the hollow-cylindrical structural component of the aircraft. In this case, a form-fitting connection between the battery holding device and the structural component can be guaranteed.

One advantageous design embodiment of the aircraft is distinguished in that the external shape of the support of the battery holding device corresponds to a portion of the geometric shape of the operational space of the structural component. Even when the structural component is configured so as not to be hollow-cylindrical but, for example, in the manner of a U-shaped support component, it is advantageous for the shape of the support of the battery holding device to correspond to at least one portion of the operational space. This guarantees a form-fitting disposal of the battery holding device in the operational space of the structural component.

### BRIEF DESCRIPTION OF THE DRAWINGS

Further features, advantages and possible uses of the present invention will emerge from the following description of the exemplary embodiments and from the figures. Here, all of the features described and/or illustrated in the figures form the subject matter of the invention individually and in any desired combination, even independently of the composition thereof in the individual claims or of the back-references thereof. Furthermore, in the figures, the same reference designations are used for identical or similar objects.

In the figures:

FIG. 1 shows a first advantageous design embodiment of the battery holding device in a schematic perspective view;

FIG. 2 shows an advantageous design embodiment of the aircraft in a schematic perspective view;

FIG. 3 shows a collective view of an advantageous design embodiment of the battery holding device and of a structural component of an aircraft in a schematic perspective view; and

FIG. 4 shows a further advantageous design embodiment of a collective view of a battery holding device and of the structural component in a schematic perspective view.

### DETAILED DESCRIPTION OF THE PREFERRED EMBODIMENTS

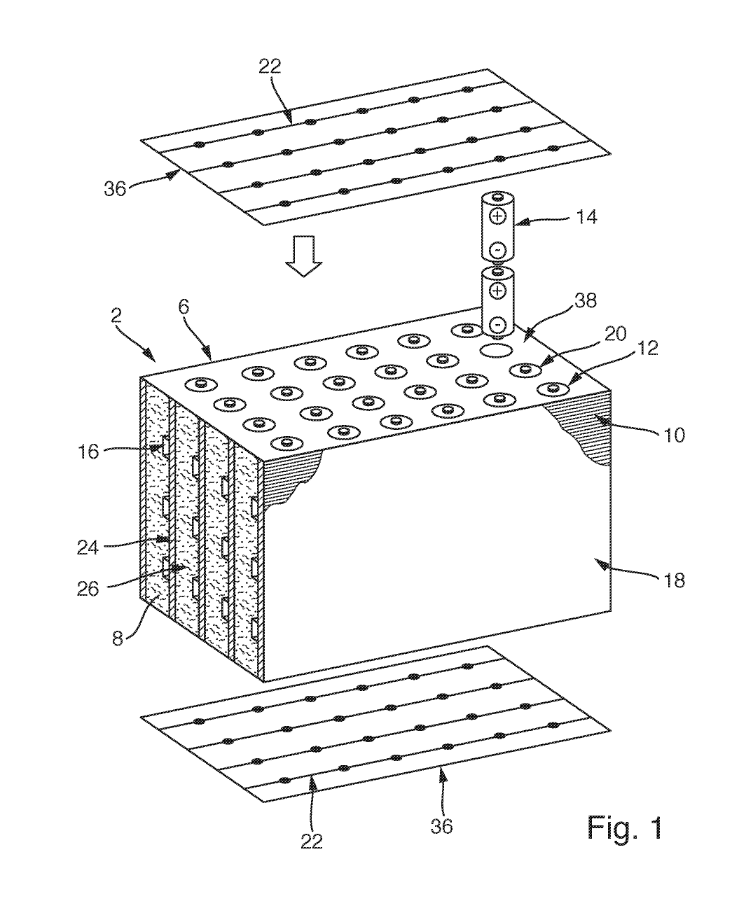

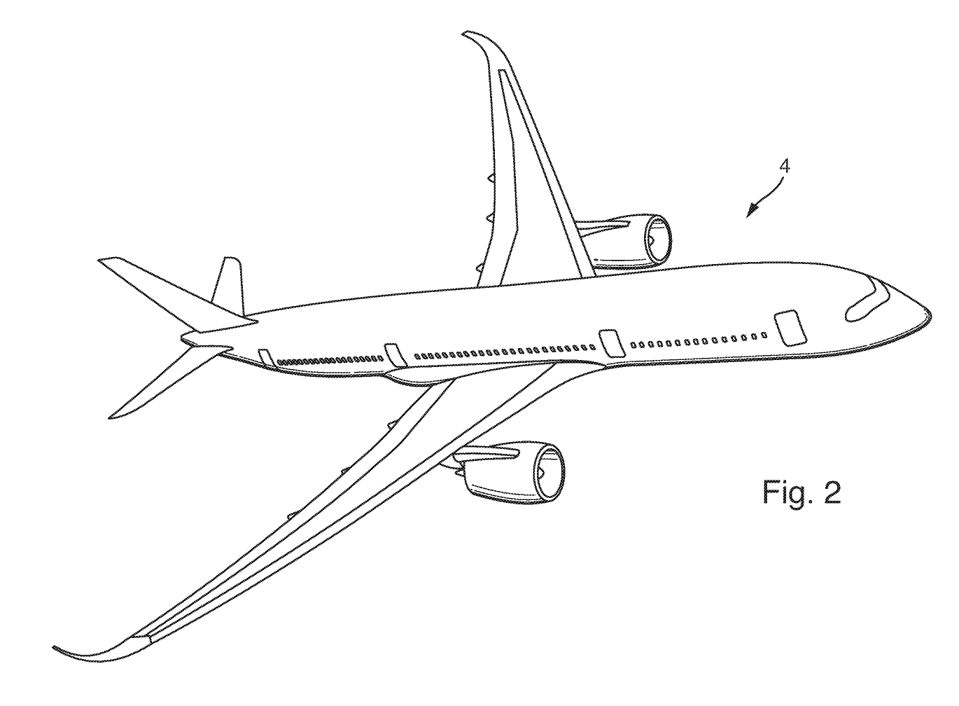

An advantageous design embodiment of the battery holding device 2 for an aircraft 4 is reproduced in a schematic perspective view in FIG. 1. An example of an aircraft 4 is schematically illustrated in FIG. 2.

The battery holding device 2 is particularly suitable for use in an aircraft 4, since the battery holding device 2 has a lower weight 2, provides a high dimensional stability, and moreover permits particularly easy access to the cavities 12 for batteries 14.

In order for the aforementioned advantages to be achieved, the battery holding device 2 has a support 6 which is formed from solid foam 8 and continuous-fiber-reinforced plastic material 10 that is connected to the foam 8. The foam 8 and the continuous-fiber-reinforced plastic material 10 can thus configure the support 6 as to be integral. The continuous-fiber-reinforced plastic material 10 and the foam 8 are preferably connected to one another in a materially integral manner. The continuous-fiber-reinforced plastic material 10 can be a thermosetting or thermoplastic matrix material, for example, in which continuous fibers, preferably from carbon, are embedded. However, other fibers, for example glass fibers or aramid fibers, can also be provided for the fibers embedded in the matrix material.

A plurality of cavities 12 are formed by the support 6. It is preferably provided herein that the cavities 12 are formed only by the solid foam 8 of the support 6. It is therefore preferably provided that the continuous-fiber-reinforced plastic material 10 of the support 6 does not have any direct contact with any of the cavities 12. Rather, the continuous-fiber-reinforced plastic material 10 of the support 6 serves for increasing the strength of the support 6 or of the foam 8, respectively. A framework and/or a pattern of stanchions and/or tile-shaped elements can herein be formed by the continuous-fiber-reinforced plastic material 10 of the support 6. This can guarantee a particularly high rigidity and/or dimensional stability which is correspondingly transmitted to the support 6. The cavities 12 that are preferably formed by the foam 8 can be designed in such a manner that batteries 14 are insertable into the cavities 12 in a form-fitting manner. This guarantees that the batteries 14 can be held in a particularly secure manner in the cavities 12. A desired positioning of the batteries 14 can be guaranteed by the foam 8, on the one hand. Moreover, the foam 8 offers a damping function for the batteries 14 when the battery holding device 2 is exposed to shocks and/or other mechanical impacts.

As can be schematically derived from FIG. 1, a plurality of batteries 14 can also be inserted into one or each cavity 12, respectively. It has proven advantageous herein for each cavity 12 to be designed in such a manner that a plurality of batteries 14 are insertable successively in a row into the respective cavity 12 in a form-fitting manner. In this case, the length of the cavity 12 can be configured so as to be a multiple length of a battery 14.

In terms of the batteries 14, it is not mandatory for the batteries 14 to have a bar-shaped or cylindrical shape, respectively. Batteries 14 of other shapes can also be used. In this case, the cavity 12 can be adapted to the external shape of the at least one battery 14, in particular, in such a manner that a form-fitting receptacle of at least one battery 14 is guaranteed on the respective cavity 12.

The battery holding device 2 moreover has at least one cooling duct 16. The at least one cooling duct 16 serves for cooling batteries 14 that are insertable into the cavities 12. It has proven advantageous herein for the at least one cooling duct 16 to be embedded within the support 6 such that the cooling duct 16 can be led past the cavities 12 in a particularly close manner. The cooling duct 16 herein can configure at least one portion of an internal-side wall for delimiting a cavity 12.

As is shown in an exemplary manner in FIG. 1, it is preferably provided that the cavities 12 are disposed so as to be mutually parallel. In this case, one cooling duct 16 can be led past a plurality of cavities 12. Moreover, a wall for forming the cooling duct can simultaneously form, in each case, one portion of an internal wall for delimiting the aforementioned cavities 12, this guaranteeing a particularly effective transmission of heat which is dissipated by batteries in the cavities 12 and which is capable of being transmitted to a cooling fluid that flows in the cooling duct 16. The cooling duct 16 can be connected to a cooling line system and/or be configured to be connected to a cooling line system. A liquid coolant or a gaseous coolant can be used as the coolant. In the use of the battery holding device 2 the cooling duct 16 can thus be releasably coupled to a cooling system of the aircraft 4. It has proven advantageous herein for air to be used as the coolant.

It is moreover advantageous for the battery holding device 2 to have a multiplicity of cooling ducts 16. The cooling duct 16 can extend between two opposite external sides of the support 6. The cooling ducts 16 at the respective end sides can be designed so as to be open. This offers the potential for the cooling ducts 16 to be able to be coupled to a cooling system of an aircraft 4 in a particularly simple manner.

The foam 8 of the support 6 of the battery holding device 2 is preferably a closed-pore polyurethane foam. The foam 8 herein can be produced by a printing method, in particular by 3D printing methods. This offers the potential for the continuous-fiber-reinforced plastic material 10 of the support 6 to be embedded in the foam 8. The continuous-fiber-reinforced plastic material 10 of the support 6 can also be produced by a printing method, in particular a 3D printing method. It is thus possible, for example, that the foam 8 as well as the continuous-fiber-reinforced plastic material 10 of the support 6 are produced by an uninterrupted method, in particular, an additive method. This offers the advantage that a particularly robust materially integral connection can be established between the foam 8 and the continuous-fiber-reinforced plastic material 10. Moreover, the method explained above offers the potential for the cavities 12 to be formed not subsequently but directly when printing the foam 8. The complexity for producing the support 8 is minimized on account thereof. A subsequent removal of foam material for producing the cavities 12 is thus dispensed with.

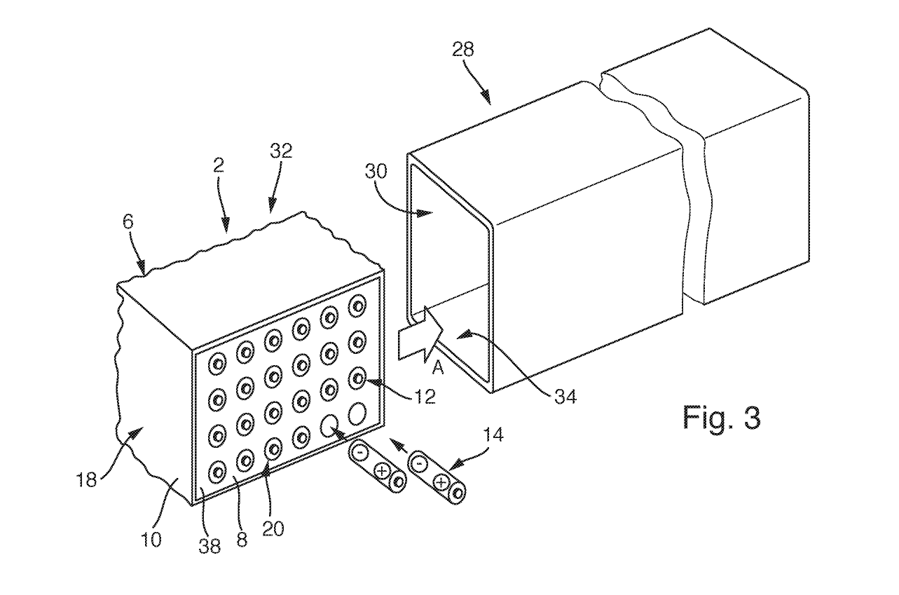

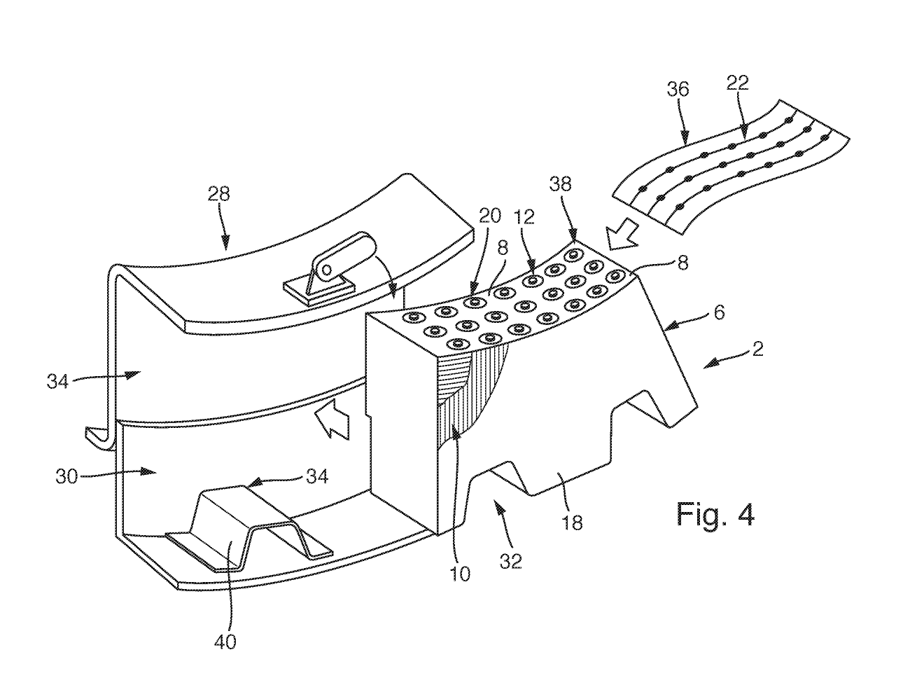

The printing method explained above moreover offers the advantage that the external design and/or shape of the support 6 or of the battery holding device 2, respectively, is adaptable to the respective individual intended use. Further examples of the battery holding device 2 are shown in FIGS. 3 and 4. It can be seen from each of the two mentioned figures that the support 6 can have another external shape 32 which is adapted to an internal shape 34 of an operational space 30 of a structural component 28 of the aircraft 4. The adaptation is preferably performed in such a manner that a form-fitting connection between the battery holding device 2 and the structural component 28 is guaranteed.

In order to prevent that a material reinforcement of the structural component 28 for the structural component 28 of the aircraft 4 is required for supporting the battery holding device 2 when a battery holding device 2 is inserted in to the operational space 30, it is preferably provided for the battery holding device 2 that the latter has a particularly dimensionally stable and/or rigid support 6. The dimensional stability of the support 6 herein can be facilitated by the batteries 14 that are insertable into the cavities 12. When batteries 14 are thus inserted into the cavities 12, a battery supporting device 2 which has a particularly high flexural rigidity and/or torsional rigidity can be created on account thereof. In other words, it can be preferably provided that this battery holding device 2 is configured so as to be self-supporting. When the battery holding device 2 is now inserted into the operational space 30 of the structural component 28, this does at least not substantially lead to any flexing of the structural component 28.

In order for the dimensional stability of the battery holding device 2 to be further increased, it has proven advantageous for the support 6 to be subdivided into a plurality of sections 28 by walls 24. Each wall 24 herein is preferably likewise configured from continuous-fiber-reinforced plastic material 10. This herein can be the same continuous-fiber-reinforced plastic material 10 as has been explained above in the context of the support 6. It is therefore particularly preferably provided that the walls 24 and the continuous-fiber-reinforced plastic material 10 of the support 6 are configured so as to be integral. The walls 24 and the support 6 can therefore be configured by an uninterrupted method, in particular, produced by a printing method. The walls 24 preferably extend in the same direction. The walls 24 can be disposed so as to be mutually parallel and spaced apart within the support 6. A section 26 is therefore adjacent to each wall 24. At least part of the foam 8 can be disposed between the walls 24. The cavities 12 are formed by the foam 8. As can be schematically derived in an exemplary manner from FIG. 1, a plurality of cavities 12 for each section 26 can be formed by the foam 8.

It is moreover preferably provided that at least one portion of the cooling duct 16 or one of the cooling ducts 16 is disposed in each wall 24. The cooling duct 16 herein can at least in part be delimited by the wall 24. The cooling duct 16 on the side of the casing can moreover be delimited by a further fiber-reinforced plastic material. As can be derived in an exemplary manner from FIG. 1, a multiplicity of cooling ducts 16 are preferably provided. The cooling ducts 16 can be disposed so as to be mutually parallel.

In order to prevent that the batteries 14 that are inserted into the cavities 12 are already electrically linked by the foam 8, it is preferably provided that the foam 8 is configured so as to be electrically isolating. Moreover, it is preferably provided that the continuous-fiber-reinforced plastic material 10 of the support 6 as well as the walls 24 is disposed so as to be spaced apart from the end-side openings of the cavities 12 in such a manner that no electrical coupling between the batteries 14 that are inserted into the cavities 12 is established by the continuous-fiber-reinforced plastic material 10 or the walls 24, respectively.

Rather, it is preferably provided that the battery holding device 2 has electrical connection lines 22 which are disposed so as to electrically connect the batteries that are insertable into the cavities 12 according to a predetermined circuit diagram. The electrical connection lines 22 can be disposed and/or embedded within the support 2, or at least in part be integrated in the support 6. For example, electrical connection lines 22 can thus extend so as to be embedded within the foam 8. This is however not illustrated in the figures. Rather, an exemplary design embodiment in which the electrical connection lines 22 are disposed on a foil/film 36 is illustrated in FIG. 1. The connection lines 22 can be disposed on the foil/film 36 in such a manner that a desired circuitry between a plurality of batteries 14 can be guaranteed by means of the connection lines 22.

It can be schematically seen in an exemplary manner from FIG. 1 that the cavities 12 are disposed so as to be mutually parallel in such a manner that an access 20 for each cavity 12 is configured on an external side 38 such that one or a plurality of batteries 14 are insertable into each cavity 12 by way of the associated access 20. Accesses 20 of this type can be configured by the foam 8 on opposite external sides 38 of the support 6. The length of the cavities 12 in the axial direction herein can be designed in such a manner that the opposite terminals of a battery 14, or the opposite terminals of a row of batteries 14, are disposed on the opposite accesses 20. This offers the advantage that the terminals of the batteries 14 can be electrically connected to one another in a predetermined manner on a foil/film 36 by means of the connection lines 22. As soon as the batteries 14 are inserted into the cavities 12, the foil/films 36 can thus be disposed on the aforementioned opposite external sides 38, this guaranteeing the desired electrical coupling of the batteries 14. The foils/films 36 can be releasably connected to the support 6. This offers the advantage that the foils/films 36 in this instance can be assigned to the battery holding device 2. The battery holding device 2 can be capable of being handled as a unit.

The afore-mention battery holding device 2 in this instance can specifically be push-fitted in the axial direction A into a cavity 30 that is formed by a structural component 28. The cavity 30 of the structural component 28 herein can form an operational space 30 which is protected and/or defined by the structural component 28. As has been explained above, it is preferably provided that the external shape 32 of the battery holding device 2 corresponds to the internal shape 34 of the structural component 28 such that a form-fitting connection between the battery holding device 2 and the structural component 28 can be guaranteed.

It is therefore likewise provided that an aircraft 4 having a structural component 28 and a battery holding device 2 is provided, wherein batteries 14 are inserted into the cavities 12 of the support 6 of the battery holding device 2, and wherein the battery holding device 2 is releasably inserted into the operational space 30 of the structural component 28.

A further advantageous design embodiment of the collective view between the structural component 28 of the aircraft 4 and the battery holding device 2 is shown in FIG. 4. The structural component 28 has an at least substantially U-shaped cross section. However, a reinforcement profile 40 is disposed on the lower leg of the structural component 28. In order to guarantee that the battery holding device 2 is insertable into the operational space 30 of the structural component 28 of the aircraft 4 in a form-fitting manner, it is preferably provided that the external shape 32 of the battery holding device 2 at least substantially corresponds to the internal shape 32 of the operational space 30 of the structural component 28.

It has been established in practice that friction can arise between an external side 18 and the structural component 28. It is therefore preferably provided that at least part of the fiber-reinforced plastic material 10 of the support 6 is disposed on at least one external side 18 of the support 6. The part of the fiber-reinforced plastic material 10 can thus contribute to the battery holding device 2 being particularly robust and durable.

It is furthermore pointed out that features that have been described with reference to one of the above exemplary embodiments may also be used in combination with other features of other exemplary embodiments described above.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise,” “having” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A battery holding device for an aircraft, comprising:
a support formed from a solid foam and continuous-fiber-reinforced plastic material that is connected to the foam;
a plurality of cavities into which batteries are insertable; and
at least one cooling duct for cooling the batteries that are insertable into the cavities,
wherein the cavities are formed by the support.

2. The battery holding device according to claim 1, wherein the continuous-fiber-reinforced plastic material of the support is a printed material.

3. The battery holding device according to claim 1, wherein at least part of the continuous-fiber-reinforced plastic material of the support is disposed on at least one external side of the support.

4. The battery holding device according to claim 1, wherein the foam is a printed material.

5. The battery holding device according to claim 1, wherein the foam is configured so as to be electrically isolating.

6. The battery holding device according to claim 1, wherein the cavities are disposed within the support, wherein an access to each cavity is configured in a further side or an external side of the support such that a battery is insertable into each cavity by way of the associated access.

7. The battery holding device according to claim 1, wherein each cavity is configured for receiving a plurality of batteries.

8. The battery holding device as claimed in claim 1, further comprising electrical connection lines which are disposed for electrically connecting the insertable batteries in a predetermined structure.

9. The battery holding device according to claim 8, wherein the connection lines are at least in part integrated in the support.

10. The battery holding device according to claim 9, wherein the connection lines are wholly contained within the support.

11. The battery holding device according to claim 1, wherein the support is subdivided into a plurality of sections by walls, wherein each wall is formed from continuous-fiber-reinforced plastic material, and wherein the walls and the continuous-fiber-reinforced plastic material of the support are configured so as to be integral.

12. The battery holding device according to claim 11, wherein at least one portion of the cooling duct or one of the cooling ducts is configured on each wall.

13. The battery holding device according to claim 9, wherein the walls and the support are configured so as to be printed by an uninterrupted method.

14. An aircraft comprising:
a structural component, and
a battery holding device according to claim 1,
wherein at least one battery is inserted into each cavity of the support of the battery holding device, and
wherein the battery holding device is at least one of releasably disposed, fastened in an operating space that is protected, or defined by the structural component.

15. The aircraft according to claim 14, wherein the structural component is configured so as to be hollow-cylindrical.

16. The aircraft according to claim 15, wherein the support of the battery holding device has an external shape which corresponds to an internal shape of the hollow-cylindrical structural component of an aircraft.
